(19) United States
(12) Patent Application Publication
(10) Pub. No.: US 2016/0027318 A1
(43) Pub. Date: Jan. 28, 2016

(54) Motivational and Practice Aid App

(71) Applicant: Amitabh Rao, Hudson, OH (US)

(72) Inventor: Amitabh Rao, Hudson, OH (US)

(21) Appl. No.: 14/806,567

(22) Filed: Jul. 22, 2015

Related U.S. Application Data
(60) Provisional application No. 62/027,896, filed on Jul. 23, 2014.

(51) Int. Cl. G09B 5/06

(52) U.S. Cl. CPC G09B 5/06

(57) ABSTRACT

An application and system to enhance educational interaction between teachers, students, and parents. The application may be implemented on any electronic device platform including, but not limited to, personal computers, laptops, smartphones and tablet computers. The application comprises a teacher module, a student module and a parent module. The teacher module enables a teacher to give multimedia practice instructions using various electronic devices as well track the quantity and quality of home practice done by the student with the intent to improve that student's skill level. The student module encourages better practice habits in the young (minor child) student as the student knows that his or her teacher and parents know how much and how he or she is practicing at all times. The parent module allows the busy parent to remotely monitor the child's development by being able to view both the teacher's instructional material as well as the child's home practice. Lastly, through peer feedback, friendly competition, awards, as well as gamification, the child is constantly motivated to increase the consistency, quality, and quantity of his or her practice.

### CROSS-REFERENCE TO RELATED APPLICATIONS

The present application relates and claims priority to U.S. provisional patent application No. 62/027,896 filed on Jul. 23, 2014.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

1. Field of the Invention

The present invention relates generally to a mobile and web application, more particularly the present invention relates to tracking students, logically grouping the students, assigning the students' practice instructions in a particular discipline, recording, and uploading practice content, providing and tracking comments and ratings, and reviewing statistical trends of students' practice habits. The present invention provides several value-added benefits for teacher, parent, and student roles, thus improving communication and interaction amongst these aforementioned roles in any discipline. As a result of this, students are more engaged, enthused, and motivated to practice and achieve more in the discipline.

2. Description of the Related Art

Traditional education in a variety of disciplines is often conducted in a physical environment such as a classroom, studio, workshop, or similar setting, either privately, or in groups. Instruction generally occurs in this type of setting in private or in groups. After instruction in a classroom, studio, or workshop, students are assigned homework, and additional assignments designed to reinforce material taught in the classroom. The quality of supplemental work (i.e. home practice) completed outside of the classroom is particularly important if a student wishes to properly retain learned material and acquire new skills. Students are able to challenge themselves to achieve more by not only getting involved in friendly competitions, but also by setting goals and tracking their own progress against those goals. Additionally, parents play a critical role in their children's advancement but often lack visibility into the instructions given by the teacher or an awareness of both the quality and quantity of home practice done by their children.

The advancement of electronic and mobile technology has greatly facilitated instructor's ability to monitor their student's progress as well as distribute assignments intended to aid in educational retention and improvement. Instructors are now able to electronically transmit educational materials such as lectures, homework assignments, literature, and textbook passages. Students are able to access these materials from virtually any electronic device such as a desktop/laptop computer, tablet computer or smartphone. These types of online educational systems are often limited to academia and are generally not adapted to additional disciplines. Online education systems may be implemented on various types of fields including, but not limited to, music, sports and fitness, performing arts, and martial arts etc. In addition to classroom/studio instruction, students in these fields are almost always tasked with home practice material that is designed to increase improvement in the particular field.

The present invention is an application and system that is designed to enhance educational interaction and engagement amongst the user base. In the preferred embodiment of the present invention, the user base comprises teachers, students, and parents. Additionally, the application may also be utilized by adult student users as well who do not require parental supervision, rendering the role of the parent unnecessary. The application may be implemented on any electronic device platform including, but not limited to, personal computers, laptops, smartphones and tablet computers. The application comprises a teacher module, a student module and a parent module.

The teacher module allows a teacher user to confirm association requests from students, group the students logically, set up assignments with instructions, manage assignments, set up awards to be won by students or groups, and set up events where students or groups are able to perform. The teacher user is able to look up the practice history of a student and use that information to map particular assignments to specific students. Assignments may be prioritized by the teacher in order to ensure that the student practices certain assignments before he/she is able to practice others. The teacher user may also give ratings to a student or group for a lesson sitting. In the student and parent modules, respectively, a student user and a corresponding parent user may view assignments that have been mapped to the student user and must be completed through the application.

A student can have multiple teachers. When choosing a teacher, a student user is able to search for a teacher user based on various criteria such as name, location, aggregate student feedback, specialty, or email ID. The student user is then able to request the teacher user to become his or her instructor. The teacher user is able to check his or her schedule and either approve or deny the student user's request. In addition, the teacher user is able to disassociate an existing student from him/her self. Conversely, the student is also able to delete an existing teacher and/or add new teachers. The teacher can see a live feed of all the practice sessions done by his/her current students, drill down to listen/view a practice recording, provide feedback and ratings, or simply “like” the practice to provide encouragement to the student. The teacher is able to see the visibility of student's relative ranking among his or her pool of students.

The student module of the application allows the student user to capture a practice session in audio or video form. For example, in the music education field, an automated metronome or an accompaniment audio track specified by the teacher may play in the background of a captured audio or video practice session. The teacher may additionally supply an accompaniment that may be played during the practice session. The student user may play the same practice multiple times in a single recording and indicate the number of repeats by pressing a “mark repeat” button. The captured media may then be uploaded to a database in the cloud that is integrated with the application of the present invention. After the media has been uploaded, the parent user and teacher user may receive notification via email, push notifications or Short Message Service (SMS). The parent user may opt in or out in order to provide approval for a captured practice session in order to police recordings and ensure quality of submitted media. The teacher user is able to view or listen to the captured practice session as well as provide feedback through the application which is viewable by both the student user and the parent user. The teacher user may additionally listen to individual repeats within a practice session by pressing on any one of the repeat segments. This allows the teacher user to ensure that the student user is not wasting practice time and is improving from repetition to repetition. The application may additionally be utilized to manage events in which the student user is participating. The teacher user may map a specific assignment (e.g. musical piece, dance routine) that the student user is scheduled to perform at a specific event in order to notify the student user that he or she is required to practice the particular assignment. The student user and parent user are also sent automated reminders of approaching events via email or SMS in order to remind the student user to practice the particular assignment. When an event, assignment or award is changed, the parent users and student users that are affected by the change are notified via email or SMS as well.

The present invention may incorporate a point-based system for practice, wherein a student is awarded a specific number of points for each minute practiced based on an algorithm. The algorithm may take into account variables such as, but not limited to, student age group, skill level, time of day, and any promotions being run by the teacher for specific periods. In addition to facilitating the distribution and review of student assignments, the application of the present invention further enables the student user or groups to earn awards for positive practice habits. The application of the present invention serves to aggregate data for a single student, group of students, or all students for practice-related statistics such as time practiced, the breakdown of practice time for particular exercises/assignments, and the student's standing amongst additional student users under the teacher user. The aggregated data is stored under the student user's profile and is utilized to assess his or her progress as well as gauge his or her practice trends. In addition to individual ranking of the student user amongst his or her peers under the same teacher user, the rankings may be extended to rankings for groups of student users under an individual teacher user, or geographically. As such, individual teacher users may be ranked against other teacher users based on the performance of their student users.

Teacher users are able to organize inter-school or inter-studio competitions as well as invite other teacher users to participate in the competitions. Other teacher users may map groups of their students to particular competitions. As a competition nears, the students and teachers receive a notification via email or SMS in order to confirm their attendance. The application of the present invention comprises a mechanism for recording competition scores as well as conferring automated awards with a leaderboard system. A history of competition data is maintained within the system of the present invention and is shareable on social media platforms. Social media integration and sharing allows promotion of teacher studios or practices, leading to future business for the teachers. Additionally, social media provides a means of encouragement for students and recognition of efforts by other students and parents.

In addition to social media integration, the application and system of the present invention comprises a social network for fostering communities within various disciplines and fields. Teachers are able to create groups for other teachers to join as well as associate themselves and their students with school-created groups. Teacher associations may additionally create groups for teachers as well. Within the social network, students may share their practice sessions publicly as well as allow friends and other students to comment on the practice sessions. Teachers are also able to share assignment instructions publicly in order to allow other teachers to utilize as well as rate the assignment instructions.

### BRIEF SUMMARY OF THE INVENTION

In one aspect the present invention is an application and system for improving educational interaction, connectivity, and engagement between teachers, students, and parents so the students can be more engaged, enthused, and motivated to practice and achieve more in the discipline. The application may be implemented on any electronic device platform such as, but not limited to, smartphones and tablet computers.

In another aspect the present invention can be used to track students, logically group the students, assign the students practice instructions in a particular discipline, record, and upload practice content, track comments and ratings, and review statistical trends of students practice habits.

### DESCRIPTION OF THE DRAWINGS

For a more complete understanding of the present invention, reference is now made to the following descriptions:

FIG. 1 is a diagrammatic overview of the application and system.

FIG. 2 is a flowchart depicting the relationship between teacher users, student users, and parent users of the application and system.

FIG. 3 is a flowchart depicting the relationship between teacher users and adult student users.

FIG. 4 is an example user interface of the teacher module home page.

FIG. 5 is a flowchart depicting system actions in monitoring, acquiring, and displaying student activity data on the teacher module live feed.

FIG. 6 is an example user interface of the teacher module assignment management page.

FIG. 7 is an example user interface of the teacher module assignment management page.

FIG. 8 is a flowchart of the assignment creation and mapping process.

FIG. 9 is an example user interface through which the teacher may monitor when a student last viewed assignment instructions.

FIG. 10 is an example user interface of the teacher module quiz creation page.

FIG. 11 is a flowchart of the practice session uploading process.

FIG. 12 is a flowchart of the teacher feedback process.

FIG. 13 is an example user interface of the teacher module event management page.

FIG. 14 is a flowchart of the event creation and mapping process.

FIG. 15 is an example user interface of the teacher module award management page.

FIG. 16 is a flowchart of the award creation, monitoring, and awarding process.

FIG. 17 is an example user interface of the teacher module goal creation page.

FIG. 18 is an example user interface of the award leaderboard page.

FIG. 19 is an example user interface of the student goal tracking page.

FIG. 20 is an example user interface of the teacher module trend management page.

FIG. 21 is an example user interface of the most popular days to practice page.

FIG. 22 is a flowchart of the practice data aggregation and statistics organization process.

FIG. 23 is an example user interface of the most effective awards page.

FIG. 24 is an example user interface of the student activity profile page.

FIG. 25 is an example user interface of the student module home page.

FIG. 26 is an example user interface of the student module assignment page.

FIG. 27 is an example user interface of the student module assignment recording page.

FIG. 28 is an example user interface of the student module pending upload page.

FIG. 29 is an example user interface of the student module award page.

FIG. 30 is an example user interface of the parent module home page.

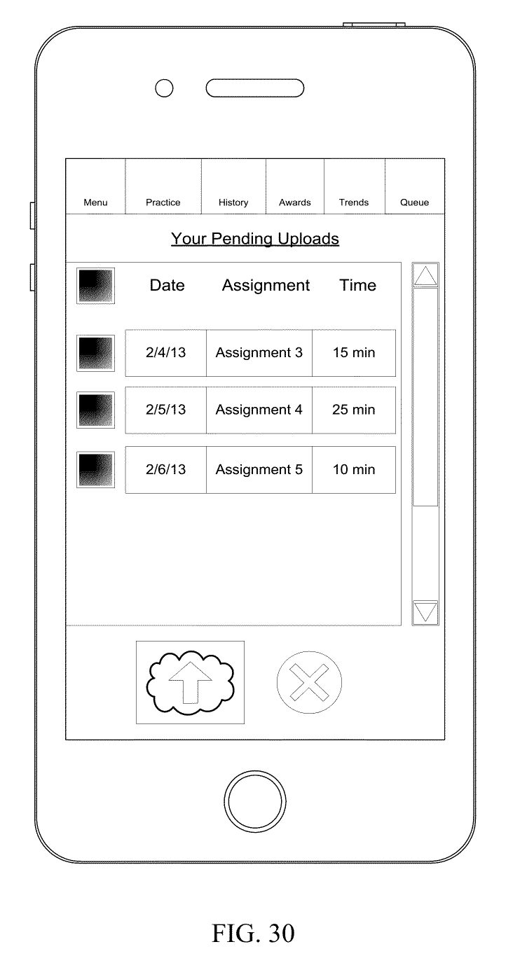

FIG. 31 is an example user interface of the parent module assignment page.

FIG. 32 is an example user interface of the parent module upload approval page.

FIG. 33 is an example user interface of the parent module event page.

FIG. 34 is a flowchart of the process of joining and associating with a teacher group.

FIG. 35 is an example user interface of the teacher point creation page.

FIG. 36 is an example user interface of the student bonus point notification page.

FIG. 37 is an example user interface of the student duel creation page.

FIG. 38 is an example user interface of the student duel notification page.

FIG. 39 is an example user interface of the student module student ranking page.

FIG. 40 is an example user interface of the teacher module student ranking page.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention. All illustrations of the drawings are for the purpose of describing selected versions of the present invention and are not intended to limit the scope of the present invention. The present invention is an application and system for improving educational interaction, connectivity, and engagement between teachers, students, and parents. In the preferred embodiment of the present invention, the application comprises a teacher module, a student module, and a parent module. The application may be implemented on any electronic device platform such as, but not limited to, smartphones and tablet computers.

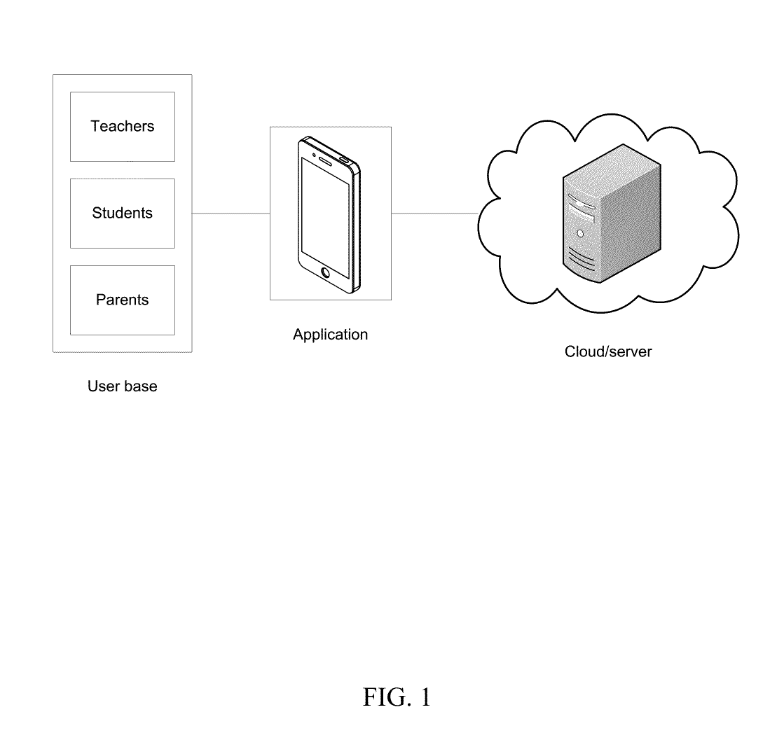

Referring to FIG. 1, the application is integrated with a supporting system backed by cloud database. The system database is capable of storing data received from a plurality of user devices such as personal computers, laptops, smartphones, and tablet computers. The system is additionally capable of routing data to various destination user devices prior to transmitting the data from the database to the devices. In the preferred embodiment of the present invention, the system is capable of transmitting and receiving various types of data including, but not limited to, text, audio, image, and video data.

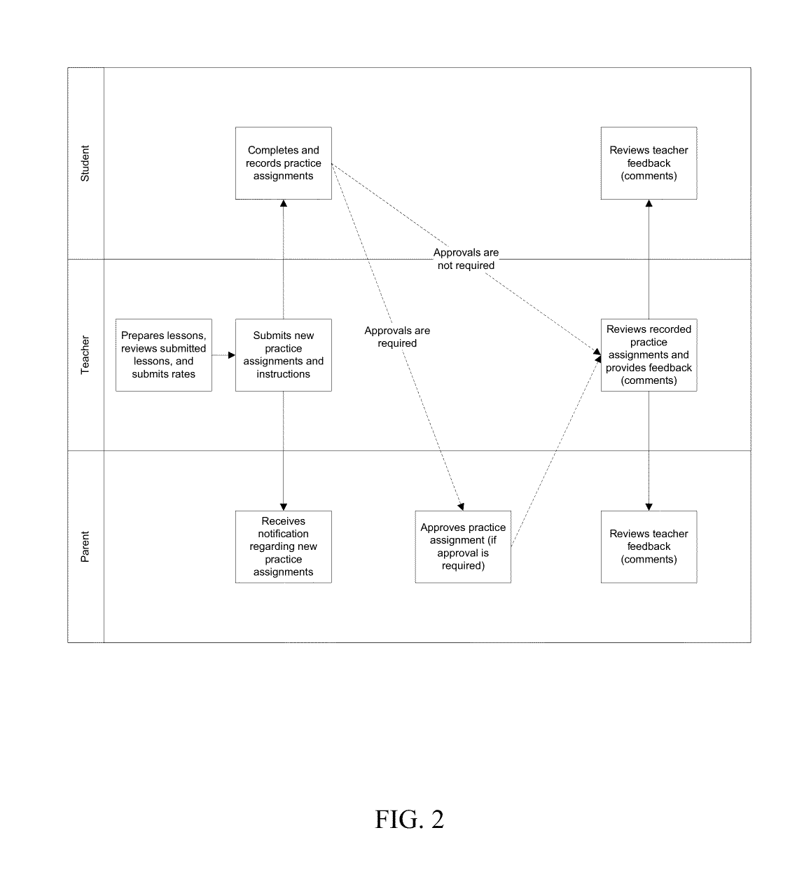

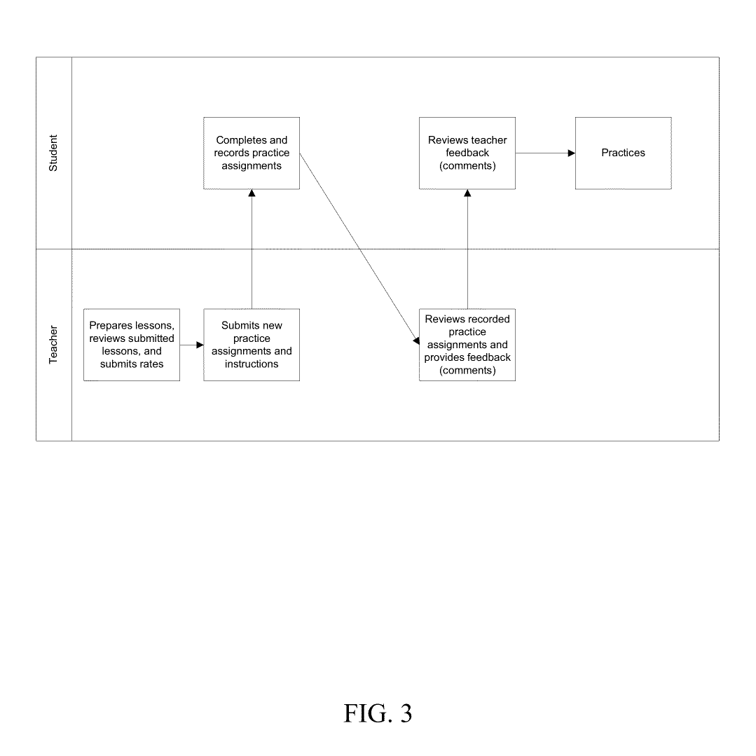

Referring to FIG. 2, the teacher module, student module, and parent module are interconnected in order to improve educational engagement amongst the user base. Referring to FIG. 3, an alternative flowchart for adult student users is in which parent user approval and supervision is not required. The application and system of the present invention are not limited to the specific educational field in which the application and system is utilized. For example, the application and system may be implemented in the fields of academia, music, sports and fitness, performing arts, and martial arts, as well as any other field in which practice and educational reinforcement outside of the classroom environment are required.

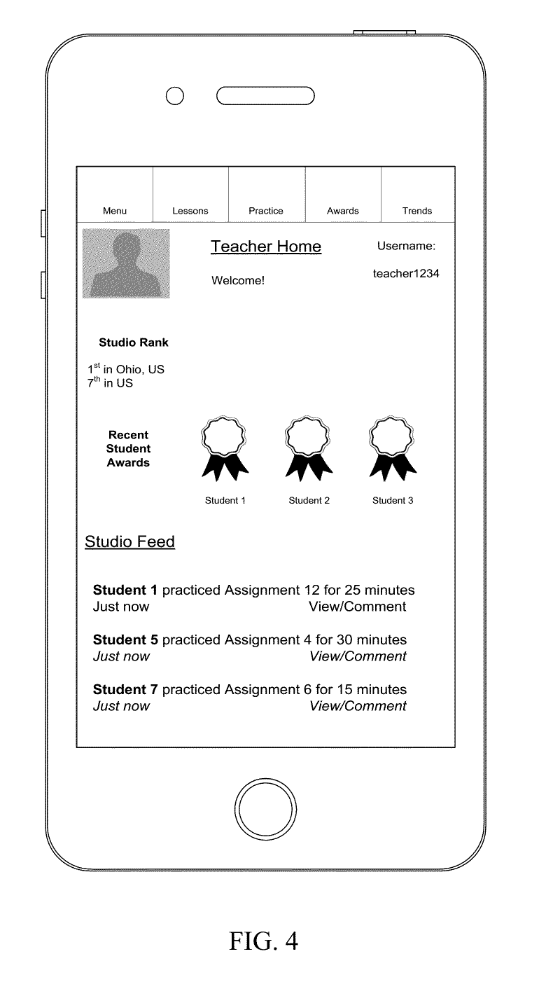

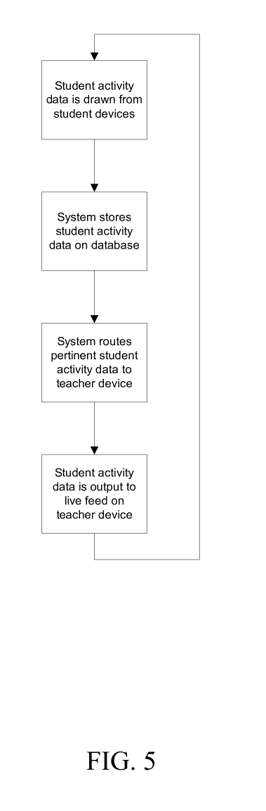

The teacher module comprises a home page that presents a general overview of the activity, progress, and achievements of the teacher user's students. Referring to FIG. 4, the teacher module home page comprises a live feed of pertinent activity such as student practice activity and upload activity. The system is capable of aggregating data relating to the activity of all students that are under the teacher's tutelage. Referring to FIG. 5, the data is stored on the system database and routed to the teacher user's device where the activity data is output on the live feed in FIG. 4. The system continuously monitors student activity in order to update the live feed. In addition to the live feed, the home page provides an overview of recent awards that have been attained by the teacher user's students. Additionally, the home page includes an overview of the teacher user's individual ranking on a local, statewide, and nationwide level. Additional criteria may be utilized to form rankings as well.

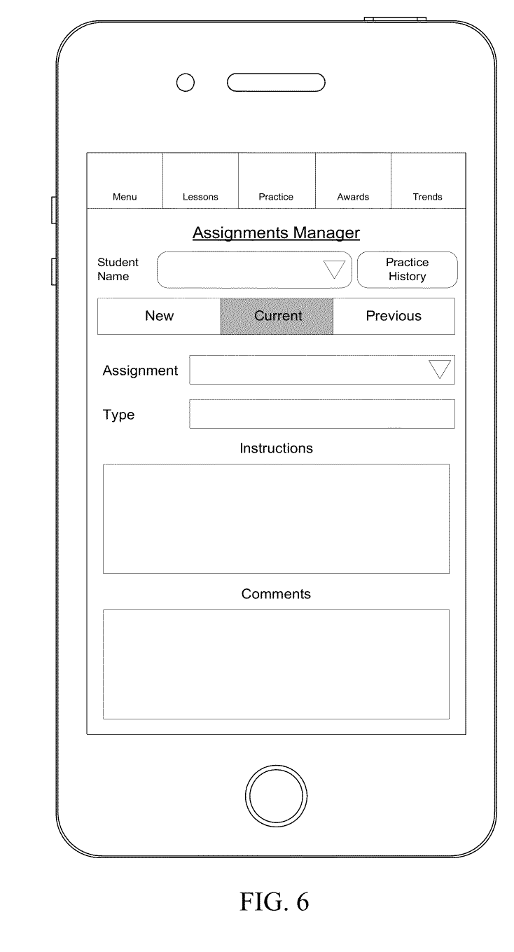

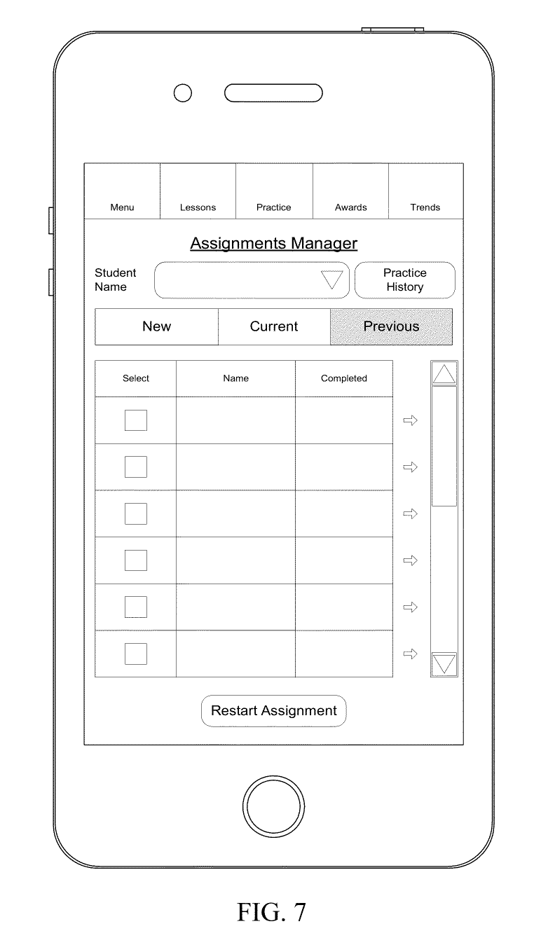

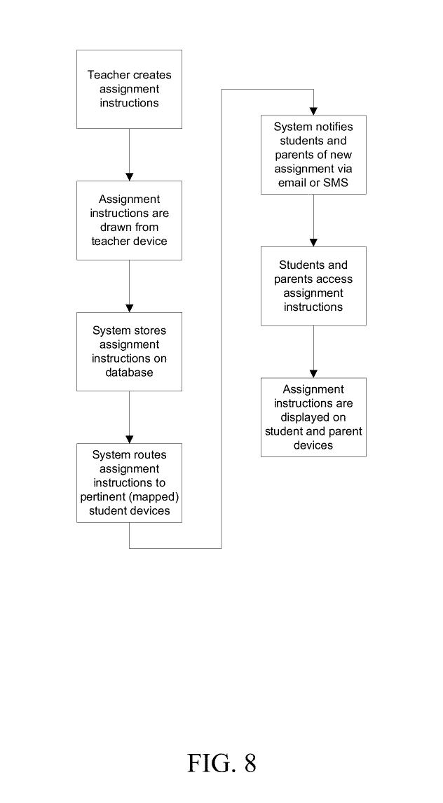

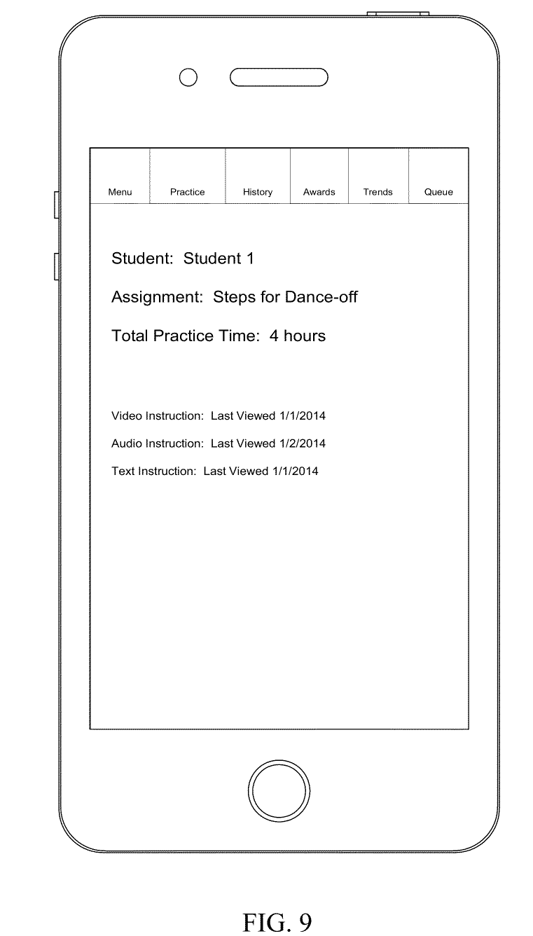

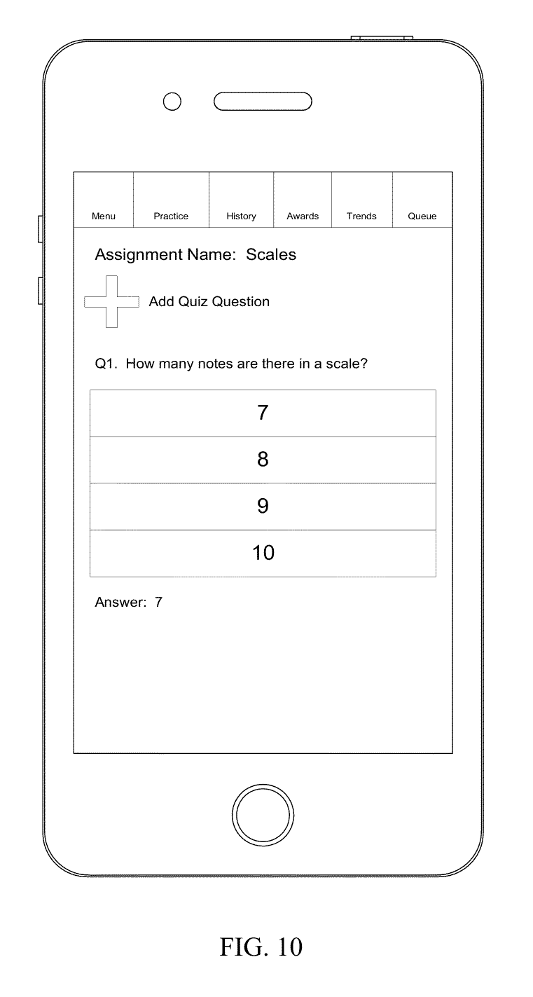

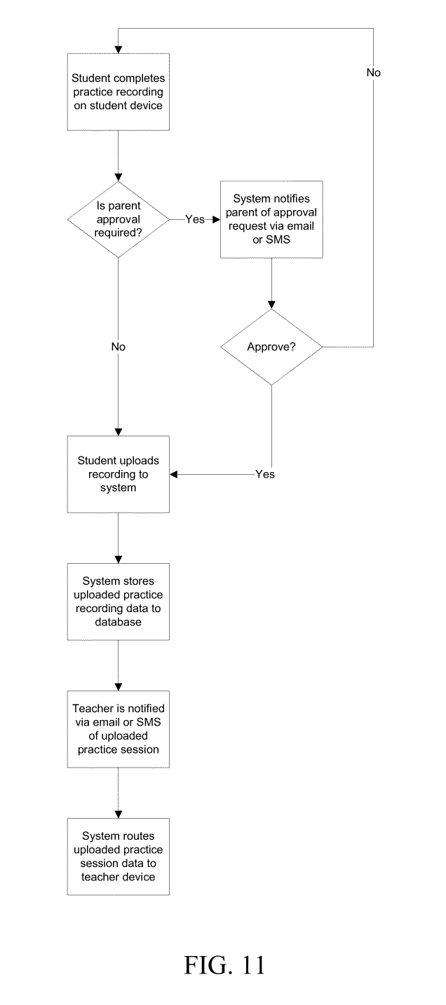

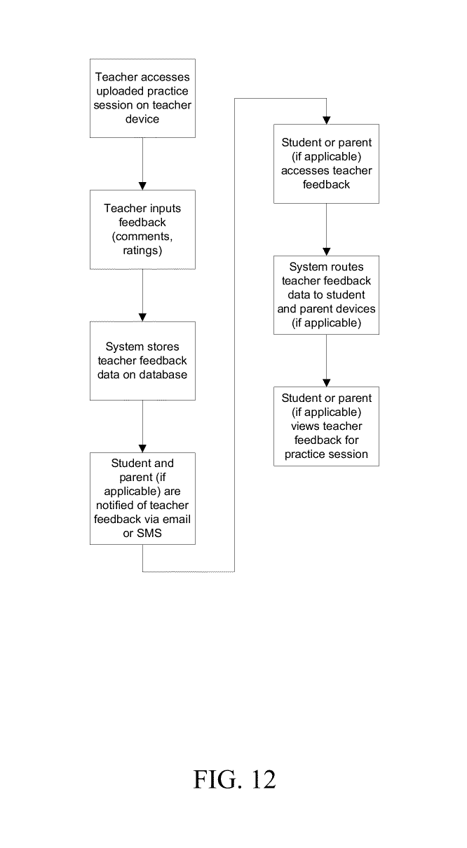

In the preferred embodiment of the present invention, the teacher user is able to create assignments for student users under his or her tutelage via an assignment management page. As shown in FIG. 6 and FIG. 7, the teacher user is able to view current and previous assignments through the assignment management page of the teacher module. Additionally, the teacher user is able to create new assignments as well as shown in FIG. 8. The teacher may provide assignment information and instructions in written, audio, image, or video form. The teacher may also indicate a book and a page number range from which the instructions have been taken. Assignment instructions are transmitted from the teacher's device and stored on the system database. After an assignment has been created, the teacher user may modify the details of the assignment if needed. The student user is notified of any changes to a new or existing assignment via email or SMS. A master copy of each assignment is retained in the system. Additionally, each copy of the assignment for each individual student may be customized. The teacher user is able to map particular assignments to specific students through the teacher module of the application. The system routes the created assignment instructions to the devices of students to whom the instructions have been mapped. After the assignment instructions have been routed to the appropriate student devices, the system notifies the students and their parents of the new assignment via email or SMS. The teacher may request to be notified when the assignment instructions have been viewed by the student user as shown in FIG. 9. The teacher user may prioritize a particular assignment in order to ensure that the student user practices the specified assignment before practicing other assignments. The system prevents the student user from recording a practice session for any assignment other than the specified prioritized assignment. Additionally, the teacher user may at any time lock a particular assignment. When an assignment is locked, the system prevents the student from accessing the assignment through the application and the student user is unable to practice the specified assignment. In addition to assignments, the teacher user may associate quizzes or tests with specific assignments as shown in FIG. 10. The student user may complete the quiz or test after practicing a particular assignment in order to gauge his or her performance and/or knowledge of the assignment. The system may also show the teacher a correlation between performance in a quiz and the quality of practice of a certain assignment. After a student user has completed an assignment, he or she is required to upload the audio or video recording of the practice session through the application. The process for uploading a recorded practice session is demonstrated in FIG. 11. The teacher user may require parent approval for an upload in order to ensure quality of an uploaded recording as well as negate any potential attempts to falsify practice session recordings. An algorithm is utilized to ensure that the student actually practiced. In the preferred embodiment of the present invention, an algorithm is utilized by the system of the present invention in order to differentiate practice audio from other sources of sound such as background noise or prerecorded sounds. The recorded practice session is uploaded to and stored on the system database in the data format selected by the student. After the recording has been uploaded, the teacher user is notified via email or SMS of the uploading. The uploaded practice session data is then routed by the system to the teacher's device. The teacher user is able to review the uploaded recording in order to provide feedback regarding the student user's performance during the practice session. Referring to FIG. 12, teacher feedback is inputted via the teacher's device and is stored on the system database. The student (and parent, if applicable) is notified of newly provided teacher feedback via email or SMS. When a student (or parent) accesses the teacher feedback, the system routes the teacher feedback data to the corresponding student or parent's device. Comments, ratings, and additional types of feedback are viewable by student users as well as parent users.

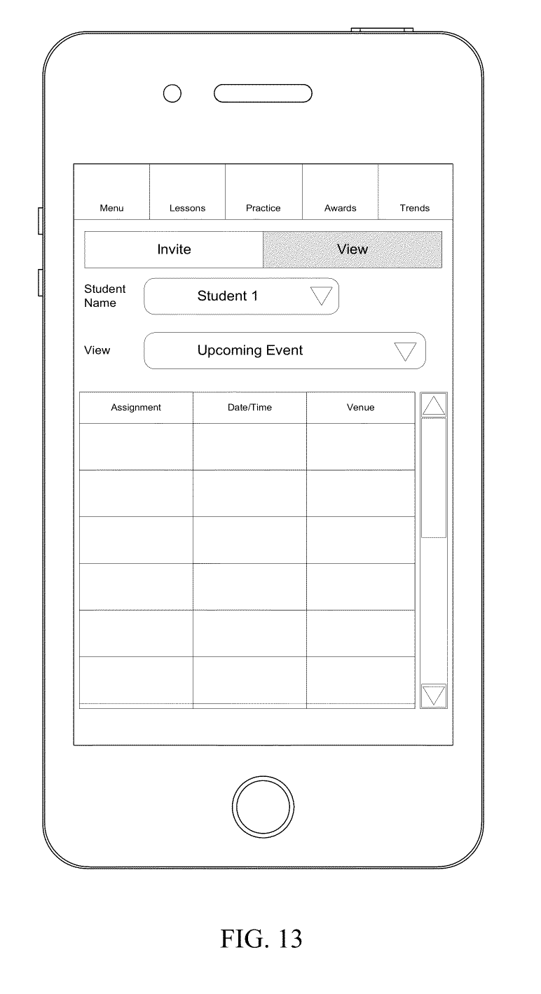

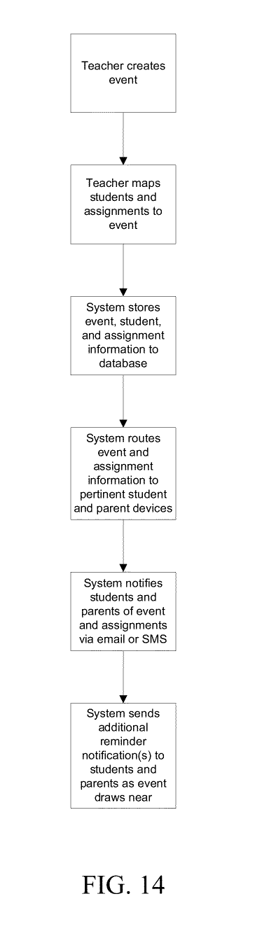

Referring to FIG. 13, in addition to creating, modifying, and mapping assignments, the teacher module of the application additionally allows the teacher user to manage events in which student users under his or her tutelage are participating. The teacher user is able to create and modify events such as recitals, performances, and competitions as well as provide information regarding the date, time, and venue of the events. As shown in FIG. 14, a teacher-created event may be assigned to a particular student with a specific assignment mapped to both the student and the event, allowing the student to prepare for the event by practicing the specific assignment. Upon creating an event and mapping an assignment to the student, the system stores the event, student, and assignment information on the system database. The event and assignment information are routed to the student and teacher devices. The student user and corresponding parent user are notified via email or SMS of the specific piece, routine, or other content that he or she is scheduled to perform at the event. The system may send additional reminders of the event and assignment to the student and parent via email or SMS as the event draws near. Additionally, if the teacher makes any modifications to the event or assignment, the system notifies the student and parent via email or SMS as well.

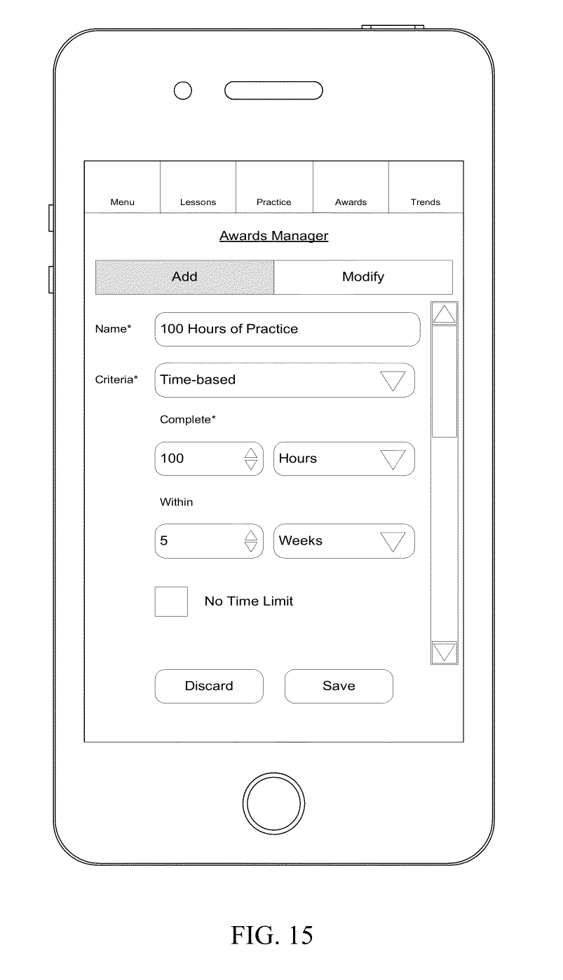

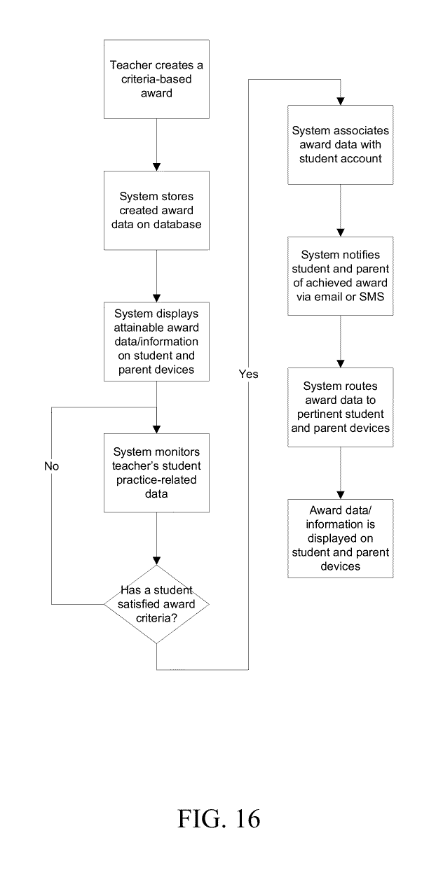

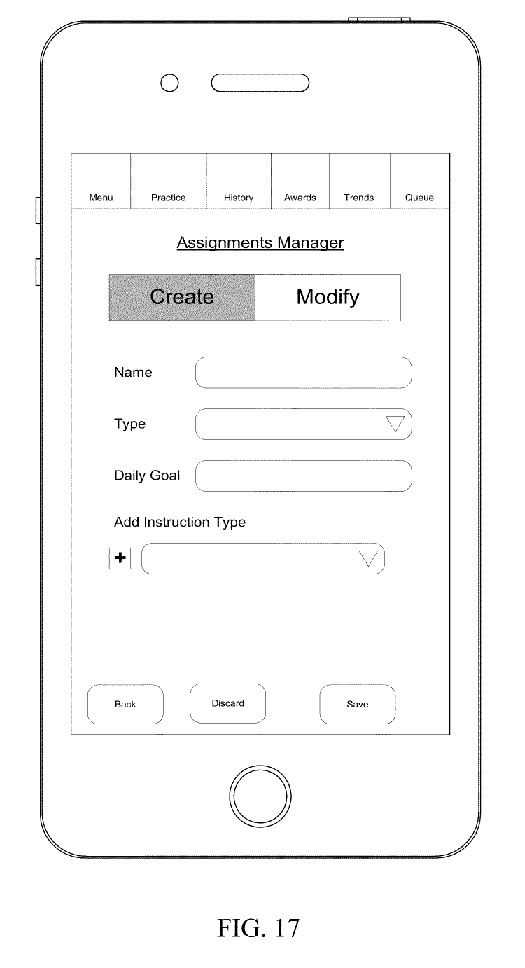

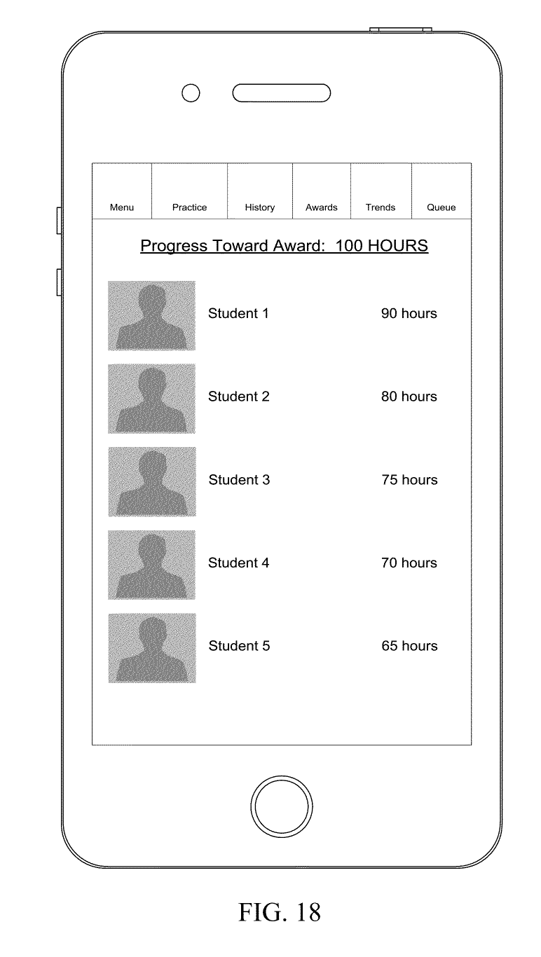

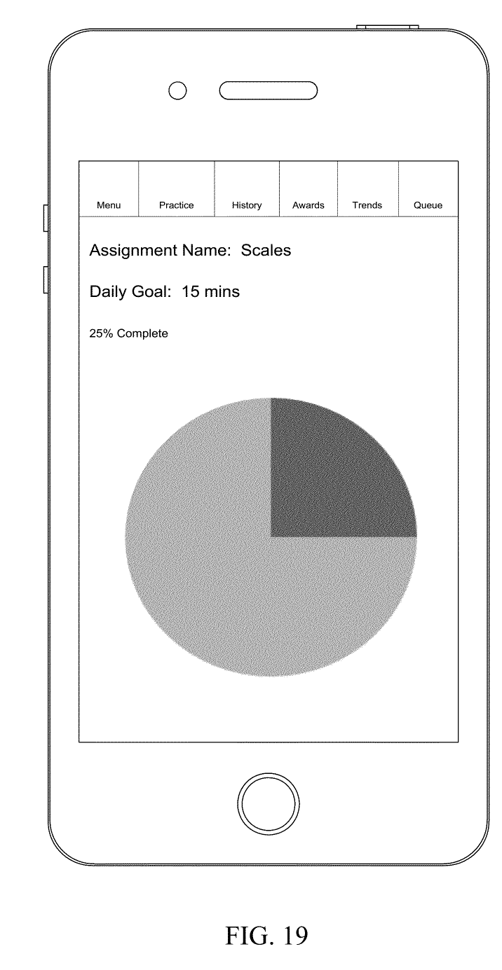

As shown in FIG. 15, the application of the present invention allows the teacher user to establish awards that are attainable by satisfying any number of criteria that are set by the teacher user. Awards serve as an additional incentive for student users to practice and improve their skills in a particular field. Criteria are generally centered on the amount of time that student users spend practicing, although additional criteria may be utilized as well such as consistency, percentage of assignments practiced, time of day practiced, and how soon the student practices after his or her session with the teacher. The process of creating, monitoring, and granting an award is shown in FIG. 16. The system stores award data on the system database. Award data is routed to and displayed on the devices of student users who are capable of attaining the awards as well as the devices of their parents. The system monitors the activity of all students under the teacher's tutelage in order to determine if the criteria for winning an award have been met by a student. If the criteria for an award have been met by a student, the system associates the award data with the student's personal account. The system additionally notifies the student (and parent, if applicable) of the achieved award via email, push notifications or SMS. The system routes award data to the pertinent student and parent devices and outputs the information on the devices for viewing as well. In addition to creating new awards, the teacher user may modify existing awards as well. Students are notified of changes to any relevant awards via email, push notifications or SMS. While student users are able to earn awards for individual performance, student users are able to compete for awards with their peers as well. The application comprises live leaderboard for an award that has not been achieved yet by a student in order to foster a sense of engagement and competition amongst students as shown in FIG. 17. Students may select a personal avatar associated with their profiles with the avatars representative of the student users and displayed on the leaderboard as shown in FIG. 18. In addition to awards, the teacher may set practice goals (related to practice time) for his or her students to work towards. The goals allow the students to track their own practice habits as well as shown in FIG. 19.

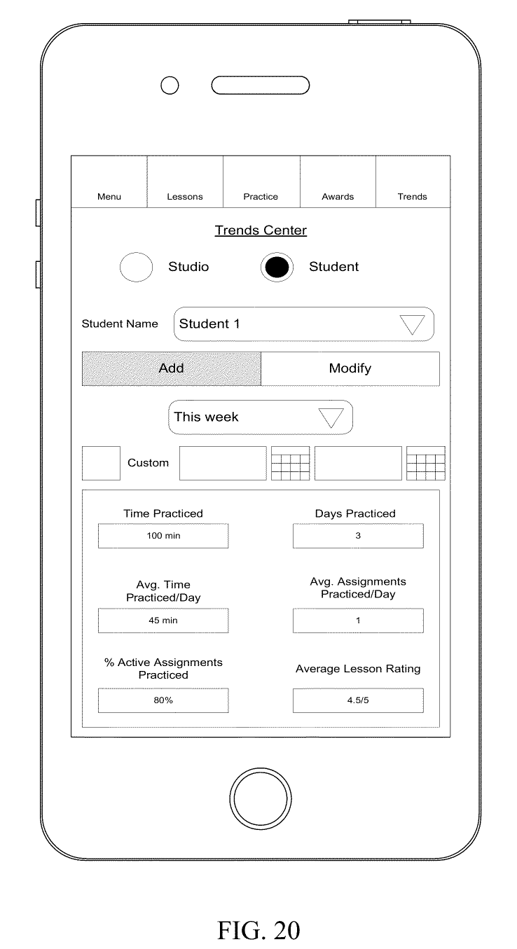

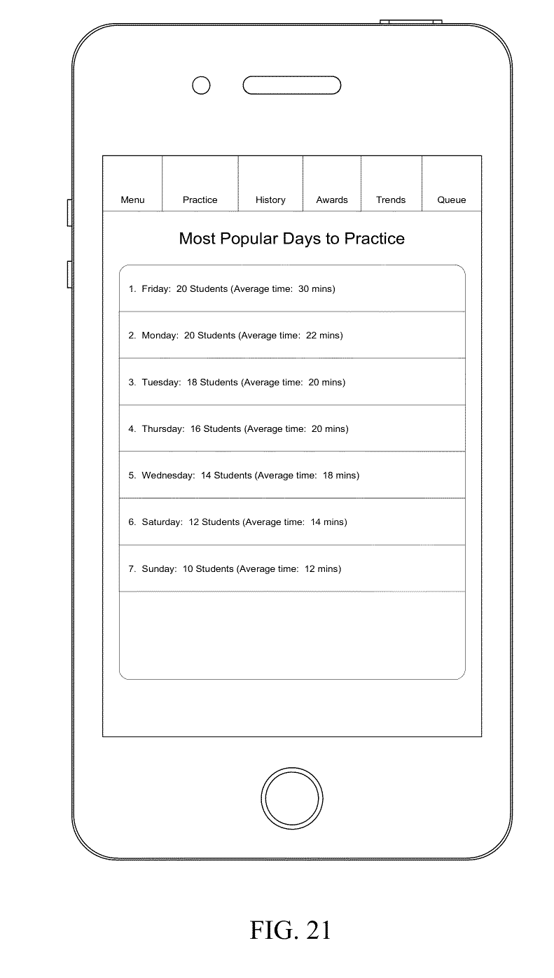

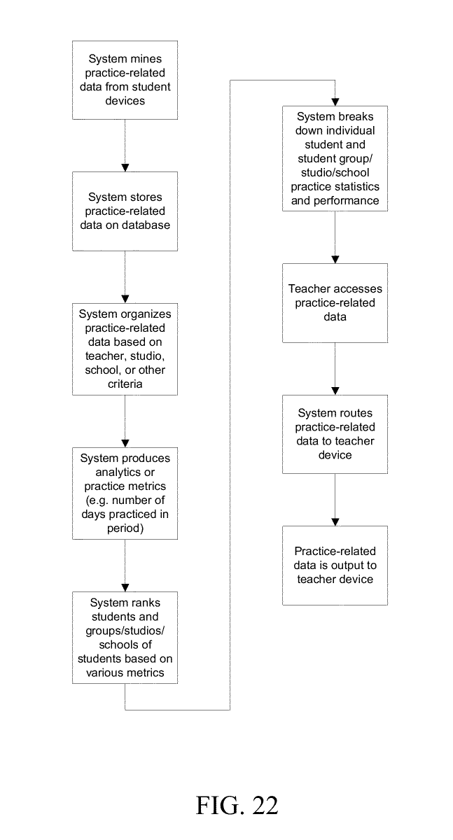

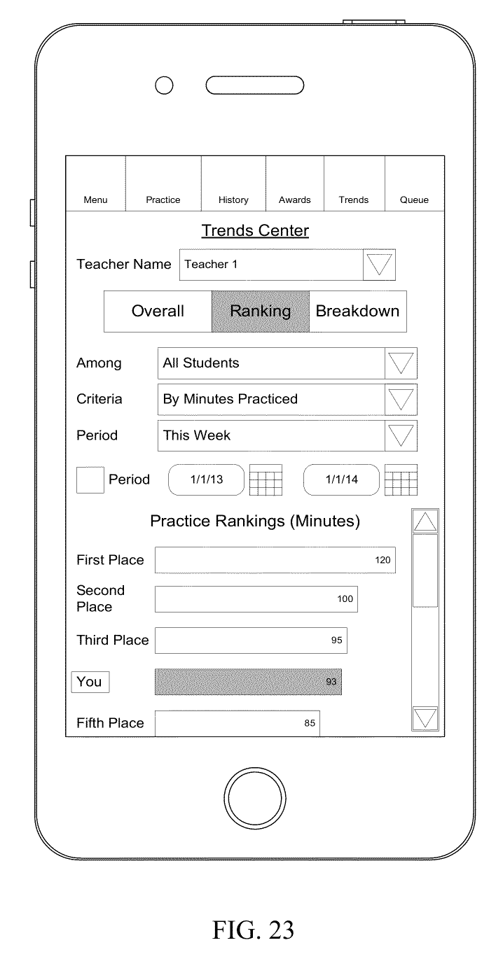

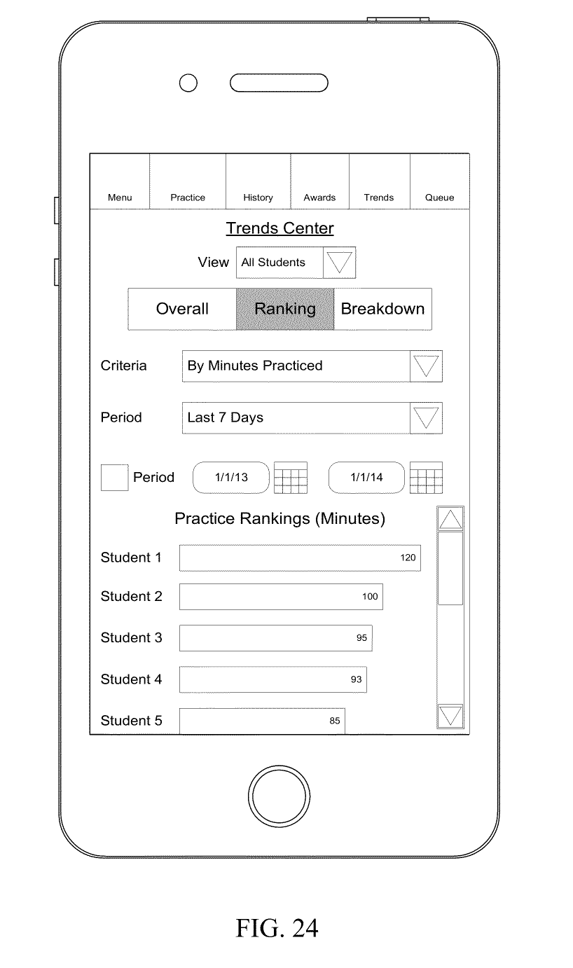

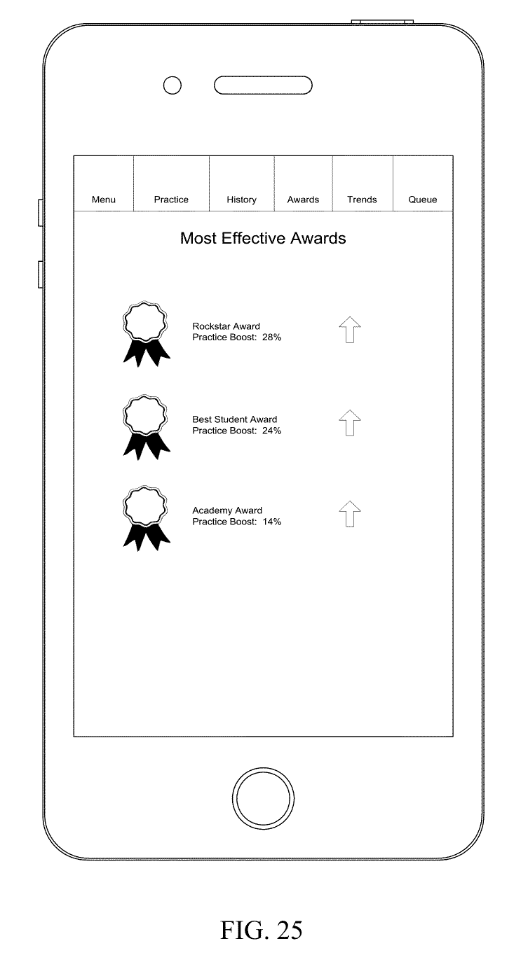

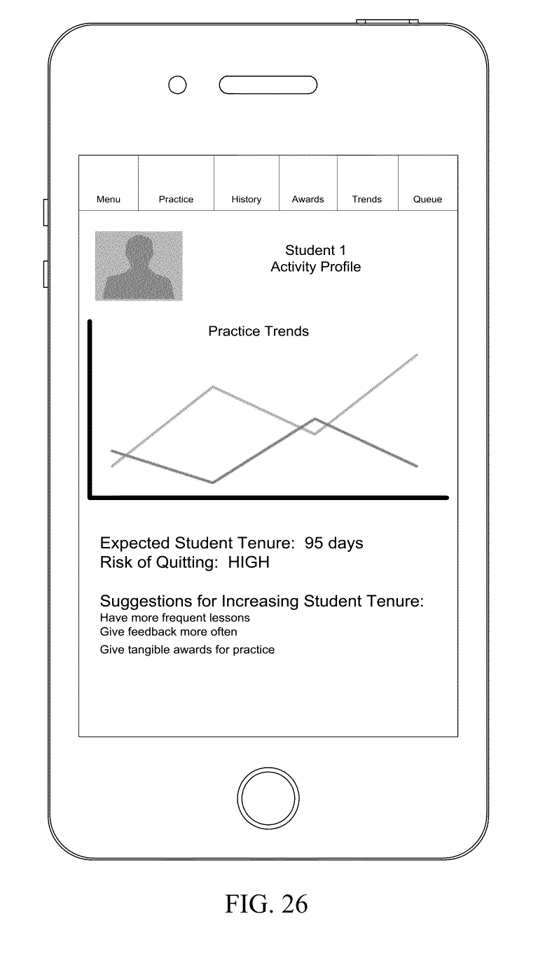

As shown in FIG. 20, the teacher module of the application further comprises a trend management page that serves to aggregate all student user data relating to practice and progress. The system of the present invention aggregates all practice-related student data and organizes the data based on teacher, studio, or other criteria. The application may provide the teacher user with a breakdown of the most popular days of the week for student practice as shown in FIG. 21. This breakdown may be determined based on average time and number of students that practiced during each day of the week. As shown in FIG. 22, practice-related data is drawn from student devices and stored onto the system database. The trend management page additionally is utilized to provide breakdowns of student user time spent practicing. This allows the teacher user to analyze practice data by identifying trends in assignment types on which the student user is focusing or not focusing. The trend management page may be utilized to assess an individual student user's ranking in relation to his or her peers under the teacher user's tutelage. The student ranking page may vary in the student module and teacher module. As seen in FIG. 23, a student may view his or her ranking relative to other students under the teacher's tutelage. Conversely, as shown in FIG. 24, the teacher is able to view the rankings of all students under his or her tutelage. Rankings may be viewed based on any number of criteria including, but not limited to, time spent practicing, average rating of practiced assignments, and percentage of active assignments practiced. In addition to ranking individual student users against other student users, the trend management page may be utilized to view the average performance of all collective student users under a single teacher user's tutelage against the collective average performance of student users of other teacher users. These group or “studio” rankings for teacher users in the same field of discipline may be based on a geographical level such as local, state-wide, or nationwide. Additional criteria may be utilized to generate rankings amongst multiple teacher users or “studios” as well. Finally, multiple teachers may be grouped into a “school” and compared with other schools within the same field or discipline. As shown in FIG. 25, the application may analyze awards as well as practice trends associated with the awards in order to determine the possible effects that certain awards have on the practice habits of students. For example, it may be determined that certain awards serve as greater motivation for students to engage in practice. The trend management page may additionally predict correlations between a student user's practice habits and his or her likelihood to succeed in the teacher user's course. For example, if a student user does not seem to possess consistent or favorable practice habits, the student may be projected to quit the course after a certain period of time. As shown in FIG. 26, the application may provide the teacher user with suggestions for increasing the length of the student user's enrollment under the teacher such as having more frequent lessons, providing more frequent feedback, and providing tangible rewards for practice.

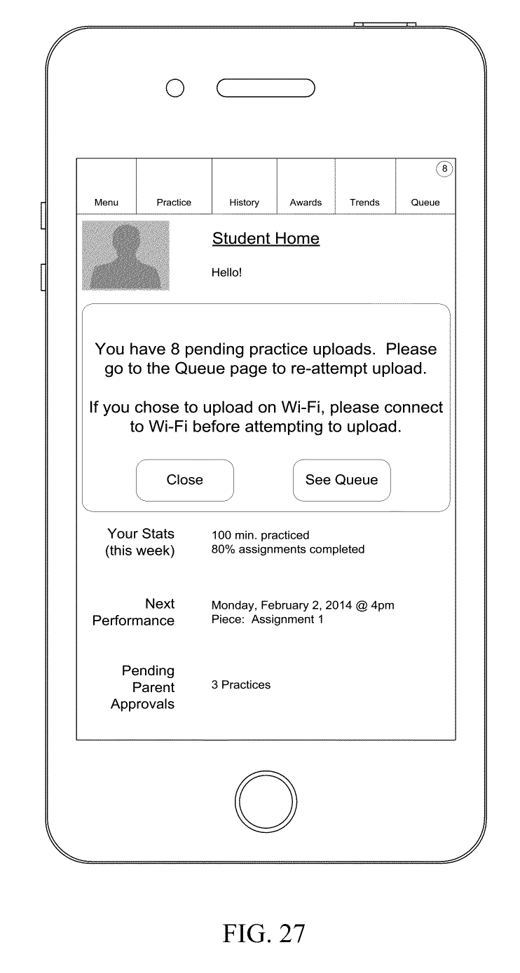

Similar to the teacher module home page, the student module comprises a homepage that provides a general overview of a student's activity as shown in FIG. 27. In the preferred embodiment of the present invention, the student module home page provides an overview of information including, but not limited to, personal (weekly) practice statistics and upcoming event information. Notifications that require the student user's attention are additionally displayed on the student module page.

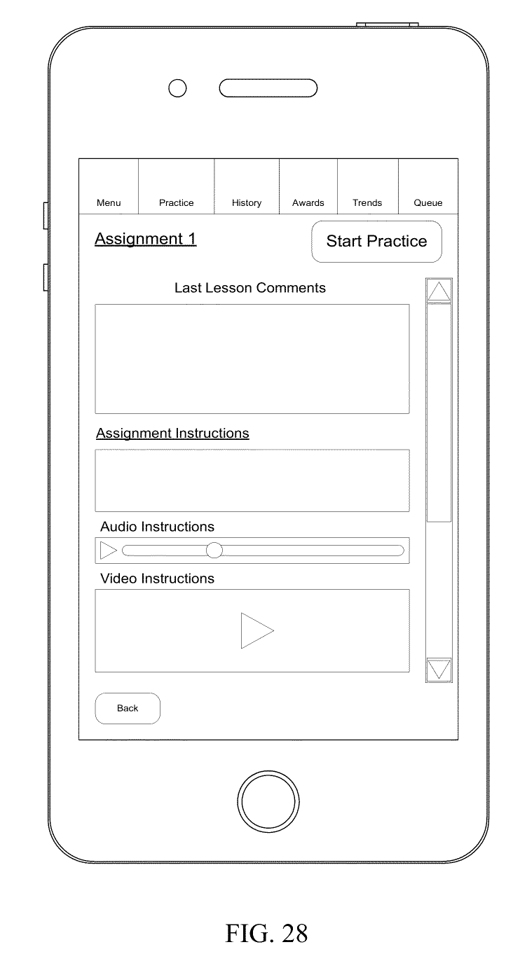

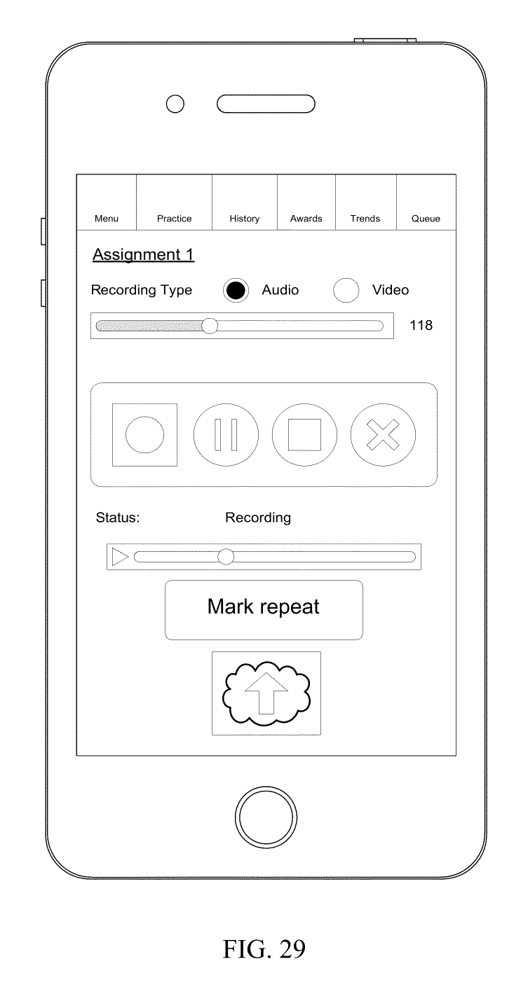

The student user is able to view all assignments that have been mapped to him or her by the teacher user through the application. As previously discussed, the teacher user is able to create and map particular assignments to specific students. Upon selecting an assignment through the student module of the application, the student user is able to view instructions and comments provided by the teacher for that particular assignment. The instructions may be in text, audio, or video form or in the form of online streaming video links from services such as YouTube or Vimeo. Upon reviewing the instructions and comments, the student user is able to initiate the practice session. As shown in FIG. 29, in the preferred embodiment of the present invention, the student user is able to capture a recording of his or her practice session. Recordings may be done in audio or video form and captured directly through the electronic device on which the student user is utilizing the application. The student may record repeats for an individual assignment on the same recording during practice. When reviewing the practice sessions, the teacher may access the various repeat segments of the recording by clicking on each individual segment. After the practice session has been captured in the desired format, the student user is able to upload the recording to the cloud database. If the student user desires, he or she may begin capturing a subsequent assignment practice session while the previously captured practice session is being uploaded. Pending uploads of recorded practice sessions are shown in the pending upload page of the student module as shown in FIG. 28. The student user is reminded of any pending uploads on his or her home page as shown in FIG. 27. Upon uploading a recorded practice session, the uploaded recording may be subject to parent approval if required by the teacher user. Once approved, the user-uploaded recording is made available for review by the teacher user. During review, the teacher user may provide feedback in the form of comments and rating scores that the student user as well as a corresponding parent user may view. Completed and reviewed assignments are stored under the student module assignment page for future access.

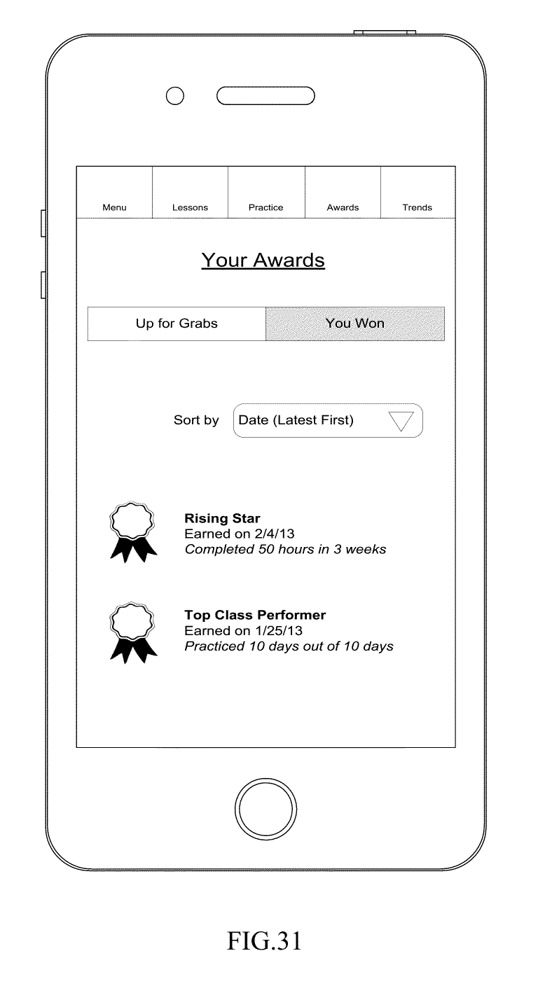

As previously discussed, the student user may earn merit-based awards through the application based on criteria that have been established by the teacher user. As shown in FIG. 31, in the preferred embodiment of the present invention, the student module award page allows the student user to view awards (“up for grabs”) that he or she has won in the past as well as currently available awards that may be attained by any student user under the teacher user's tutelage. Upon receiving an award, the student user is automatically notified through the application or via email/SMS. Additionally, similar to the teacher module, the student module further comprises a trend management page through which the student user may view aggregated personal user data. The student user may view breakdowns of his or her practice time as well as his or her individual rankings in relation to other student users. In addition to individual student user rankings, the student user may additionally view group or “studio” rankings for collective students under teacher users. Students, teachers, and parents may post and share award information and statistical practice-related data on a variety of external social media platforms.

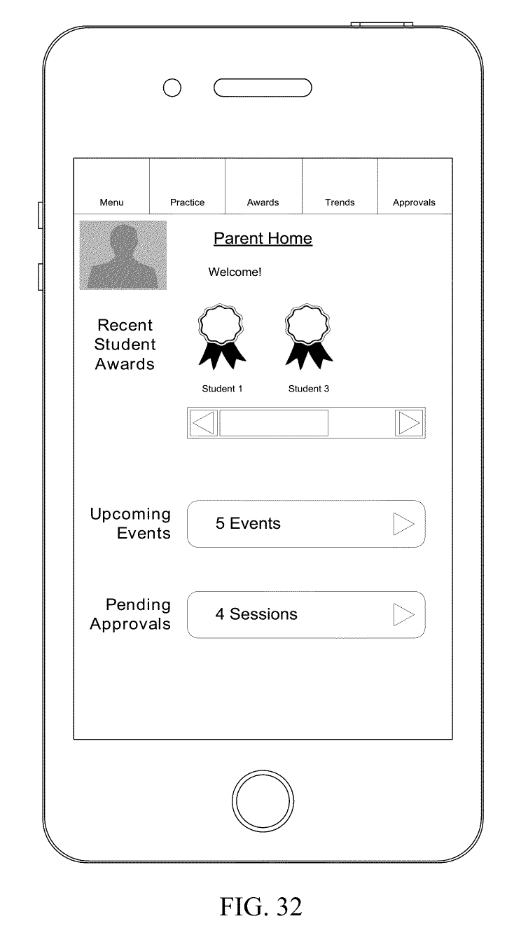

Much like the teacher module and student module, the parent module comprises a homepage that serves as a dashboard with an overview of the parent user's corresponding student user(s) as shown in FIG. 32. In the preferred embodiment of the present invention, the parent module home page displays recent awards attained by the student user(s). Additionally, the parent module home page provides a broad overview of important information related to the student user(s) such as upcoming events in which the student user(s) are participating and pending student user uploads that require the parent user's approval.

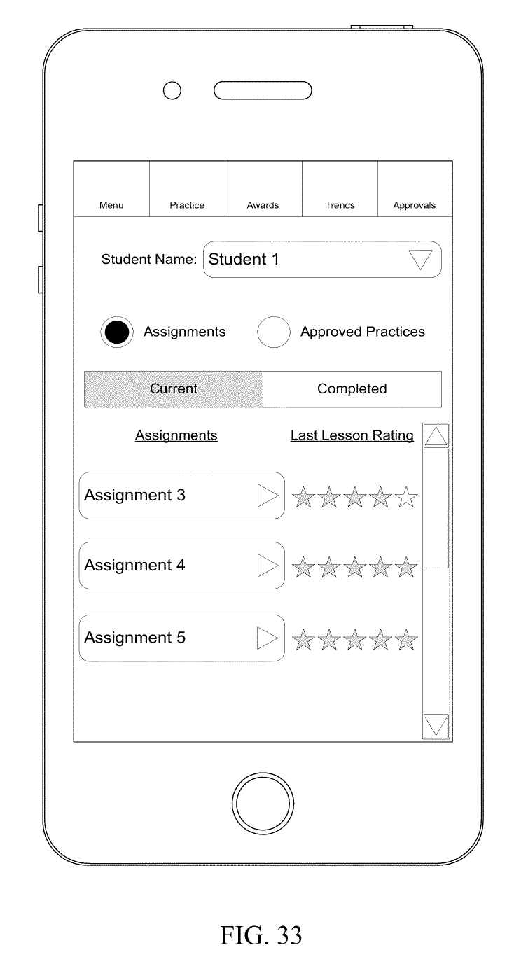

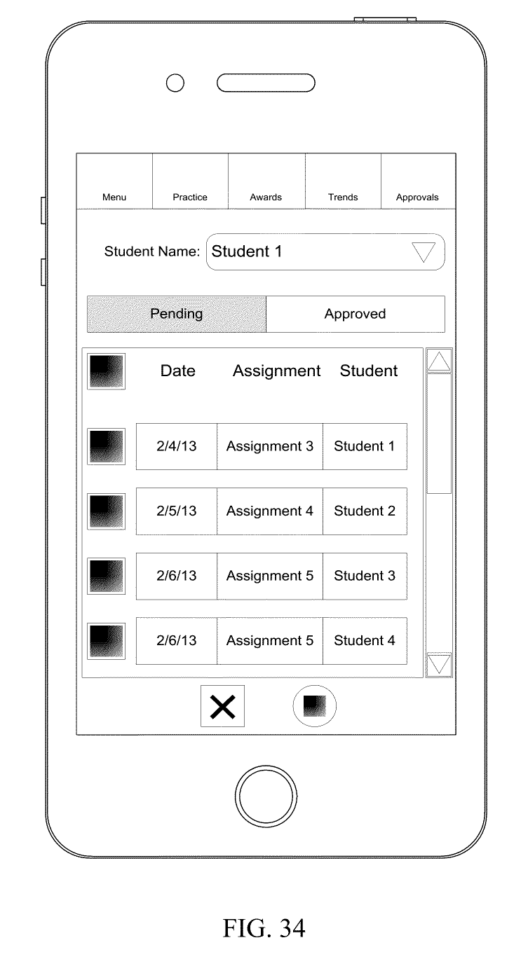

The parent module of the application is utilized by the parent user to monitor the practice activity of his or her corresponding student user(s). As shown in FIG. 33, the parent user is able to view active and completed previous assignments that have been mapped to the student user(s) as well as comments, ratings, and additional feedback provided by the teacher user for previously completed assignments. Active assignments may be filtered by the individual student user to which the assignments have been mapped. The parent user may additionally provide approval for uploaded practice session recordings provided by the student user(s). The parent user may opt in or opt out of having to provide approvals for uploaded practice recordings at his or her discretion. Pending approvals as well as previously approved recordings are displayed in the upload approval page as shown in FIG. 34. Upon reviewing and approving a recording, the recording is made available to the teacher user for review.

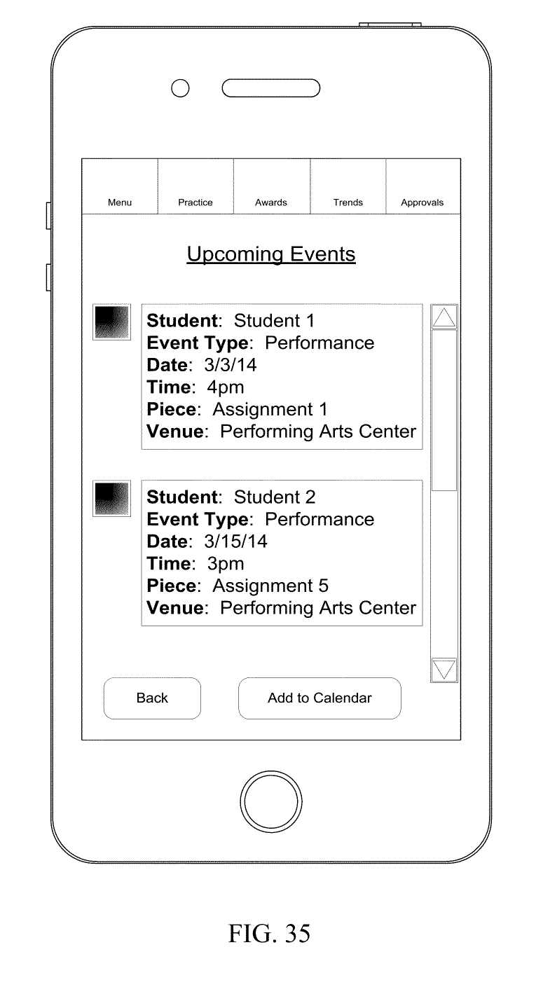

Similar to the student module of the application, the parent module may be utilized to monitor student user awards that the student user has already attained as well as potential awards that he or she may attain in the future. The parent user may additionally view student user trends, personal practice statistics, and rankings, as well as upcoming events in which the student user is scheduled to perform, as shown in FIG. 35.

Prior to utilizing the application of the present invention, a teacher user, student user, or parent user is required to register a personal account with username and password. The teacher user is able to manage student users who are under his or her tutelage. The teacher user is able to request parents and adult students to register a personal account. The parents and adult students may then search for the teacher user through the application and submit an association request. The teacher user is able to review all pending student association requests through the mobile application and approve or reject the requests. Once an association has been established either the teacher user or the student user may break off the association, at which point the student may associate with another teacher. The student user may have multiple teachers in the system or none as well.

Multiple students grouped together under the same teacher may be categorized into smaller groups such as “classes”. The categorization of multiple students into classes allows the teacher to designate a particular assignment to all students in a class. When viewing student ranks as well as student practice trends and statistics, the data may be displayed and viewed by class in addition to viewing statistics for an individual student or all students under the teacher's tutelage. Multiple teachers may be grouped together into a “school” as well and school administrators can view trends across multiple teachers in that organization. The teacher user, student user, and parent user are able to specify personal preferences and settings as well through the application. User preferences and settings include notification settings, time zone settings, and user interface settings. In the preferred embodiment of the present invention, the user may specify the particular application events for which a notification will be received. Application notifications may be transmitted and received via email, through the application itself, or via SMS.

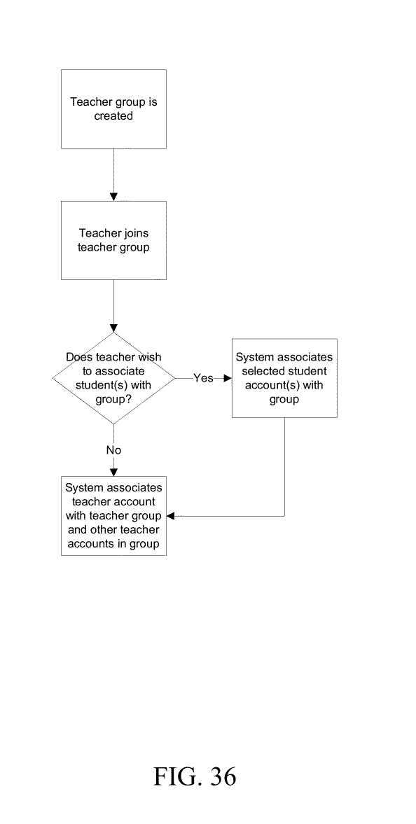

The application and system of the present invention comprises a social network in order to foster communities within various disciplines and fields. In the preferred embodiment of the present invention, teacher users may form groups for multiple teachers to join as shown in FIG. 36. Teacher associations or organizations may create groups for teachers as well. After a teacher joins a teacher group, his or her account is associated with the group by the system. In addition to teacher groups, schools are able to form groups for teachers to join. The teachers may selectively associate their students with school-formed groups. Selected student accounts are associated with the groups as well. The school-formed groups may be regulated with regard to the actions that group members may or may not perform. For example, groups may be set to view only, with no changes to the group permitted by group members. Alternatively, group members may be permitted to perform various actions such as creating awards that all student members of the group may earn. The social network of the application and system allows students to publicly share captured media relating to assignment practice sessions. Other users such as friends and acquaintances may review shared content as well as provide feedback on the students' practice sessions. Finally, the social network provides a venue for teachers to share assignment instructions on a global scale. Other teachers may view and utilize shared assignment instructions with their own students. Additionally, teachers may provide feedback for shared assignment instructions provided through the social network. Shared assignment instructions may be rated with respect to various factors including, but not limited to, assignment creativity and assignment effectiveness.

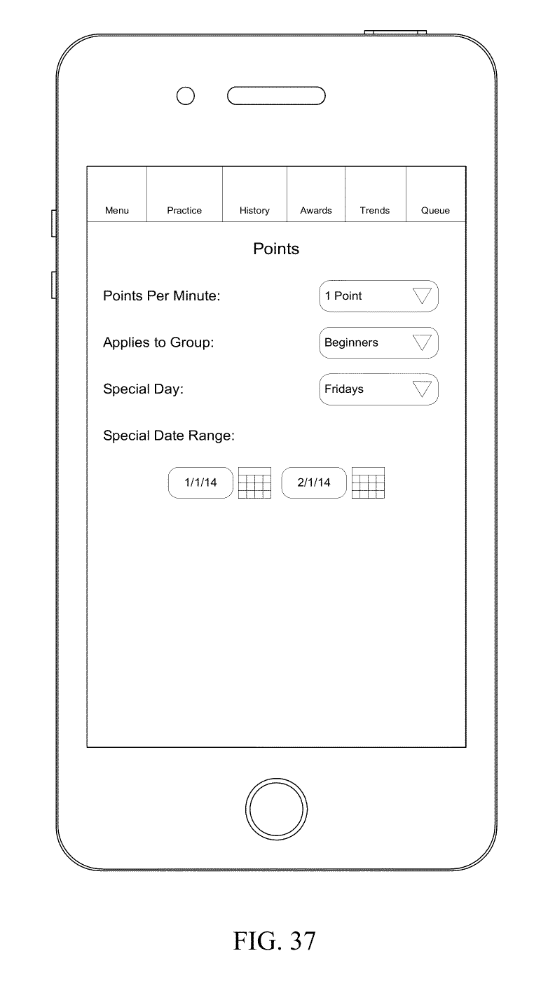

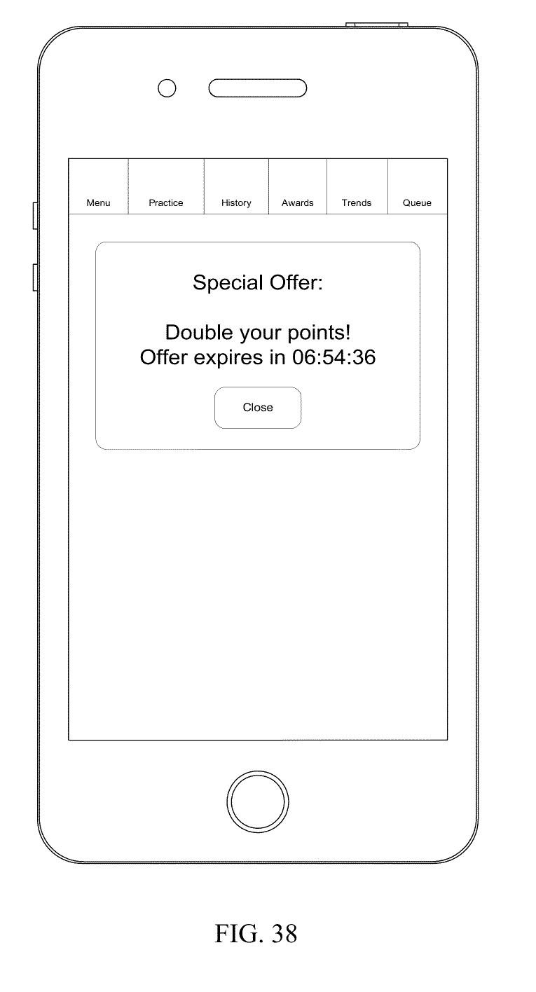

The application and system of the present invention may incorporate a point-based system for student practice sessions. In the preferred embodiment of the present invention, a student is awarded a specific number of points for each minute practiced. As shown in FIG. 37 the allocation of points to be assigned for practice is determined by an algorithm that takes into account a number of variables including, but not limited to, the particular student's age group, the student's skill level, the time of day during which practice occurred, and any promotions that are being run by the teacher during the time period in which practice occurred. For example, a teacher may establish a limited time promotion during which a student may receive double points for practicing assignments on certain days such as Fridays for instance. The student is notified of a promotion via the application as shown in FIG. 38.

The application and system of the present invention may be utilized in order to organize competitions in which students are able to participate. In the preferred embodiment of the present invention, competitions may be organized on a global scale. Additionally, students may compete individually or in teams. Competitive teams may be organized in a number of ways including, but not limited to, country (national) teams, state teams, and studio teams.

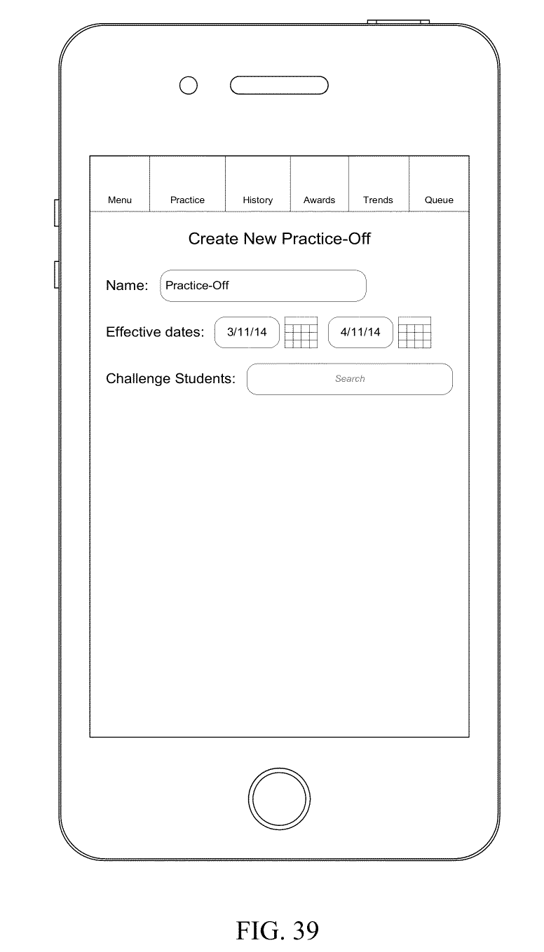

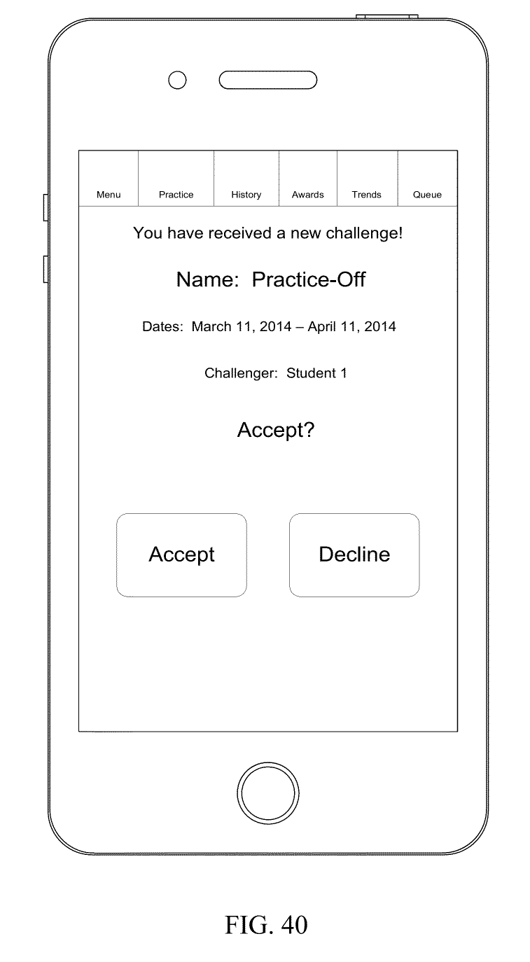

The application of the present invention may comprise a practice advisor feature that allows students to set practice-related award targets. The practice advisor additionally allows students to receive advisory messages for accomplishing certain goals such as winning targeted awards. After a student has selected a target award, he or she receives notifications such as award progress updates from the practice advisor. Referring to FIG. 39, the application of the present invention may further comprise a duel feature or “practice-off” feature through which a teacher user may set up a practice duel in which students are able to compete with one another for a specified duration of time. The student user may search for other students through the application and invite the selected students to participate in the practice duel. Invited students are able to accept or decline the invitation to engage in the practice duel as shown in FIG. 40. Although the present invention has been explained in relation to its preferred embodiment, it is understood that many other possible modifications and variations can be made without departing from the spirit and scope of the present invention.

What is claimed is:

1. A downloadable educational mobile and web application for improving educational interaction, connectivity, and engagement between teachers, students, and parents, the present application and system are not limited to the specific educational field, the application and system may be implemented in the fields of academia, music, sports and fitness, performing arts, and martial arts, as well as any other field in which practice and educational reinforcement outside of the classroom environment are required, this application may be implemented on any electronic device platform such as, but not limited to, smartphones and tablet computers, the present downloadable educational mobile and web application comprising:
a supporting system with cloud database that is capable of storing data received from a plurality of user devices, the system is additionally capable of routing data to various destination user devices prior to transmitting the data from the database to the devices, the system is capable of transmitting and receiving various types of data including, but not limited to, text, audio, image, and video data; and
three modules: a teacher module, student module, and parent module which are interconnected in order to improve educational engagement amongst the user base.

2. To use the application of claim 1, a teacher user, student user, or parent user is required to register a personal account with username and password, the teacher user is able to manage student users who are under his or her tutelage, the teacher user is able to request parents and adult students to register a personal account, the parents and adult students may then search for the teacher user through the application and submit an association request, the teacher user is able to review all pending student association requests through the mobile application and approve or reject the requests, once an association has been established either the teacher user or the student user may break off the association, at which point the student may associate with another teacher, the student user may have multiple teachers in the system, user preferences and settings include notification settings, time zone settings, and user interface settings, the user may specify the particular application events for which a notification will be received, application notifications may be transmitted and received via email, through the application itself, or via SMS.

3. The teacher module of claim 1 comprises a home page that presents a general overview of the activity, progress, and achievements of the teacher user's students. the teacher module home page comprises a live feed of pertinent activity such as student practice activity and upload activity, the system is capable of aggregating data relating to the activity of all students that are under the teacher's tutelage, the data is stored on the system database and routed to the teacher user's device, the system continuously monitors student activity in order to update the live feed, the home page provides an overview of recent awards that have been attained by the teacher user's students, the home page includes an overview of the teacher user's individual ranking on a local, statewide, and nationwide level.
the teacher user is able to create assignments for student users under his or her tutelage via an assignment management page, the teacher user is able to view current and previous assignments through the assignment management page of the teacher module, the teacher may provide assignment information and instructions in written, audio, image, or video form, the teacher may also indicate a book and a page number range from which the instructions have been taken, the assignment instructions are transmitted from the teacher's device and stored on the system database, after an assignment has been created, the teacher user may modify the details of the assignment if needed, the student user is notified of any changes to a new or existing assignment via email or SMS, a master copy of each assignment is retained in the system, the teacher user is able to map particular assignments to specific students through the teacher module of the application, the system routes the created assignment instructions to the devices of students to whom the instructions have been mapped, after the assignment instructions have been routed to the appropriate student devices, the system notifies the students and their parents of the new assignment via email or SMS, the teacher may request to be notified when the assignment instructions have been viewed by the student user, the teacher user may prioritize a particular assignment in order to ensure that the student user practices the specified assignment before practicing other assignments, the system prevents the student user from recording a practice session for any assignment other than the specified prioritized assignment, the teacher user may at any time lock a particular assignment, when an assignment is locked, the system prevents the student from accessing the assignment through the application and the student user is unable to practice the specified assignment, the teacher user may associate quizzes or tests with specific assignments, the student user may complete the quiz or test after practicing a particular assignment in order to gauge his or her performance and/or knowledge of the assignment, the system may also show the teacher a correlation between performance in a quiz and the quality of practice of a certain assignment, after a student user has completed an assignment, he or she is required to upload the audio or video recording of the practice session through the application.
the teacher user may require parent approval for an upload in order to ensure quality of an uploaded recording as well as negate any potential attempts to falsify practice session recordings, an algorithm is utilized to ensure that the student actually practiced, an algorithm is utilized by the system of the present invention in order to differentiate practice audio from other sources of sound such as background noise or prerecorded sounds, the recorded practice session is uploaded to and stored on the system database in the data format selected by the student, after the recording has been uploaded, the teacher user is notified via email or SMS of the uploading, the uploaded practice session data is then routed by the system to the teachers device, the teacher user is able to review the uploaded recording in order to provide feedback regarding the student user's performance during the practice session, teacher feedback is inputted via the teacher's device and is stored on the system database, the student (and parent, if applicable) is notified of newly provided teacher feedback via email or SMS, when a student (or parent) accesses the teacher feedback, the system routes the teacher feedback data to the corresponding student or parent's device, comments, ratings, and additional types of feedback are viewable by student users as well as parent users.
the teacher module of the application allows the teacher user to manage events in which student users under his or her tutelage are participating, the teacher user is able to create and modify events such as recitals, performances, and competitions as well as provide information regarding the date, time, and venue of the events, a teacher-created event may be assigned to a particular student with a specific assignment mapped to both the student and the event, allowing the student to prepare for the event by practicing the specific assignment, upon creating an event and mapping an assignment to the student, the system stores the event, student, and assignment information on the system database, the event and assignment information are routed to the student and teacher devices, the student user and corresponding parent user are notified via email or SMS of the specific piece, routine, or other content that he or she is scheduled to perform at the event, the system may send additional reminders of the event and assignment to the student and parent via email or SMS as the event draws near, if the teacher makes any modifications to the event or assignment, the system notifies the student and parent via email or SMS as well.
the application of the present invention allows the teacher user to establish awards that are attainable by satisfying any number of criteria that are set by the teacher user, awards serve as an additional incentive for student users to practice and improve their skills in a particular field, criteria are generally centered on the amount of time that student users spend practicing, although additional criteria may be utilized as well such as consistency, percentage of assignments practiced, time of day practiced, and how soon the student practices after his or her session with the teacher, the process of creating, monitoring, and granting an award, the system stores award data on the system database, award data is routed to and displayed on the devices of student users who are capable of attaining the awards as well as the devices of their parents, the system monitors the activity of all students under the teacher's tutelage in order to determine if the criteria for winning an award have been met by a student. If the criteria for an award have been met by a student, the system associates the award data with the student's personal account, the system additionally notifies the student (and parent, if applicable) of the achieved award via email, push notifications or SMS, the system routes award data to the pertinent student and parent devices and outputs the information on the devices for viewing as well, the teacher user may modify existing awards as well, students are notified of changes to any relevant awards via email, push notifications or SMS, while student users are able to earn awards for individual performance, student users are able to compete for awards with their peers as well, the application comprises live leaderboard for an award that has not been achieved yet by a student in order to foster a sense of engagement and competition amongst students, students may select a personal avatar associated with their profiles with the avatars representative of the student users and displayed on the leaderboard, the teacher may set practice goals (related to practice time) for his or her students to work towards, the goals allow the students to track their own practice habits.
the teacher module of the application further comprises a trend management page that serves to aggregate all student user data relating to practice and progress, the system of the present invention aggregates all practice-related student data and organizes the data based on teacher, studio, or other criteria, the application may provide the teacher user with a breakdown of the most popular days of the week for student practice, this breakdown may be determined based on average time and number of students that practiced during each day of the week, practice-related data is drawn from student devices and stored onto the system database, the trend management page additionally is utilized to provide breakdowns of student user time spent practicing, this allows the teacher user to analyze practice data by identifying trends in assignment types on which the student user is focusing or not focusing, the trend management page may be utilized to assess an individual student user's ranking in relation to his or her peers under the teacher user's tutelage.
the student ranking page may vary in the student module and teacher module, a student may view his or her ranking relative to other students under the teacher's tutelage, the teacher is able to view the rankings of all students under his or her tutelage. Rankings may be viewed based on any number of criteria including, but not limited to, time spent practicing, average rating of practiced assignments, and percentage of active assignments practiced, In addition to ranking individual student users against other student users, the trend management page may be utilized to view the average performance of all collective student users under a single teacher user's tutelage against the collective average performance of student users of other teacher users, these group or “studio” rankings for teacher users in the same field of discipline may be based on a geographical level such as local, state-wide, or nationwide, additional criteria may be utilized to generate rankings amongst multiple teacher users or “studios” as well. Finally, multiple teachers may be grouped into a “school” and compared with other schools within the same field or discipline.

4. The student module of claim 1 comprises a homepage that provides a general overview of a student's activity, the student module home page provides an overview of information including, but not limited to, personal (weekly) practice statistics and upcoming event information, notifications that require the student user's attention are additionally displayed on the student module page.
the student user is able to capture a recording of his or her practice session, recordings may be done in audio or video form and captured directly through the electronic device on which the student user is utilizing the application, the student may record repeats for an individual assignment on the same recording during practice, when reviewing the practice sessions, the teacher may access the various repeat segments of the recording by clicking on each individual segment, after the practice session has been captured in the desired format, the student user is able to upload the recording to the cloud database, if the student user desires, the student user is reminded of any pending uploads on his or her home page, upon uploading a recorded practice session, the uploaded recording may be subject to parent approval if required by the teacher user, once approved, the user-uploaded recording is made available for review by the teacher user, during review, the teacher user may provide feedback in the form of comments and rating scores that the student user as well as a corresponding parent user may view.
completed and reviewed assignments are stored under the student module assignment page for future access.
the student user may earn merit-based awards through the application based on criteria that have been established by the teacher user, the student module award page allows the student user to view awards (“up for grabs”) that he or she has won in the past as well as currently available awards that may be attained by any student user under the teacher user's tutelage, upon receiving an award, the student user is automatically notified through the application or via email/SMS.
the student module further comprises a trend management page through which the student user may view aggregated personal user data, the student user may view breakdowns of his or her practice time as well as his or her individual rankings in relation to other student users, in addition to individual student user rankings, the student user may additionally view group or “studio” rankings for collective students under teacher users. Students, teachers, and parents may post and share award information and statistical practice-related data on a variety of external social media platforms.

5. The parent module of claim 1 comprises a homepage that serves as a dashboard with an overview of the parent user's corresponding student user(s), the parent module home page displays recent awards attained by the student user(s), the parent module home page provides a broad overview of important information related to the student user(s) such as upcoming events in which the student user(s) are participating and pending student user uploads that require the parent user's approval, the parent module of the application is utilized by the parent user to monitor the practice activity of his or her corresponding student user(s).
the parent user is able to view active and completed previous assignments that have been mapped to the student user(s) as well as comments, ratings, and additional feedback provided by the teacher user for previously completed assignments, active assignments may be filtered by the individual student user to which the assignments have been mapped.
a parent user may additionally provide approval for uploaded practice session recordings provided by the student user(s), a parent user may opt in or opt out of having to provide approvals for uploaded practice recordings at his or her discretion, pending approvals as well as previously approved recordings are displayed in the upload approval page, upon reviewing and approving a recording, the recording is made available to the teacher user for review.
similar to the student module of the application, the parent module may be utilized to monitor student user awards that the student user has already attained as well as potential awards that he or she may attain in the future.
the parent user may additionally view student user trends, personal practice statistics, and rankings, as well as upcoming events in which the student user is scheduled to perform.

6. The application and system of claim 1 comprises a social network in order to foster communities within various disciplines and fields, each user may form groups for multiple teachers to join, teacher associations or organizations may create groups for teachers as well, after a teacher joins such a group, his or her account is associated with the group by the system, schools are able to form groups for teachers to join, the teachers may selectively associate their students with school-formed groups, selected student accounts are associated with the groups as well, the social network of the application and the application and system of the present invention may incorporate a point-based system for student practice sessions, a student is awarded a specific number of points for each minute practiced, the allocation of points to be assigned for practice is determined by an algorithm that takes into account a number of variables including, but not limited to, the particular student's age group, the student's skill level, the time of day during which practice occurred, and any promotions that are being run by the teacher during the time period in which practice occurred.

7. The application of claim 1 may comprise a practice advisor feature that allows students to set practice-related award targets, the practice advisor allows students to receive advisory messages for accomplishing certain goals such as winning targeted awards.

8. The application of claim 1 may further comprise a practice duel feature or “practice-off” feature through which a teacher user may set up a practice duel in which two students are able to compete with one another for a specified duration of time, the student user may search for other students through the application and invite selected students to participate in the practice duel, invited students are able to accept or decline the invitation to engage in the practice duel.
